(19) United States
(12) Patent Application Publication
(10) Pub. No.: US 2012/0067162 A1
(43) Pub. Date: Mar. 22, 2012

(54) Steering Wheel Armature Weight

(76) Inventors: STEVEN KOLLMANN, Sussex, WI (US); GIUSEPPE PETRILLO, Plymouth, MI (US)

(21) Appl. No.: 12/885,014

(22) Filed: Sep. 17, 2010

(51) Int. Cl. B62D 1/04; B21D 53/26; B62D 15/00

(52) U.S. Cl. 74/552; 16/400; 29/894.1

(57) ABSTRACT

A steering wheel weight formed as a body and having a generally curvilinear shape in a plane that is generally aligned with a longitudinal axis of the body. At least one indexer extends from the body and is oriented to align the body with respect to a steering wheel armature. At least one deformable tab extends from the body and is oriented relative to the steering wheel armature so that only deformation of the tab positionally secures the steering wheel weight relative to the steering wheel armature. Preferably, the steering wheel weight is crimped to the steering wheel armature thereby securely connecting the steering wheel weight to the steering wheel armature without extraneous fasteners/connectors.

### BACKGROUND OF THE INVENTION

The present invention relates to a weighted steering wheel armature assembly and, more particularly, to a cast weight that can be secured to the steering wheel armature assembly without supplemental connectors such as bonding agents or adhesive, fasteners that cooperate with the armature and the weight, and/or other connectors such as clips or ties.

A steering wheel armature generally consists of a rigid frame that includes a center or hub portion and a grip portion that is oriented about the hub portion. The hub portion is constructed to be secured to steering mechanism, such as a steering shaft, of a vehicle and the grip portion is constructed to be comfortably engaged by a user positioned in a driver position of the underlying vehicle. To maintain user control of the steering of the underlying vehicle, the steering wheel armature must provide a robust connection between the grip of the user and the steering shaft. Attempting to improve vehicle efficiency and reduce the material consumption associated with forming the steering wheel armature, many manufactures have reduced the weight of steering wheel armature so such an extent that the steering wheel armature assembly is susceptible to undesired vibration during operation of the vehicle. To address the undesired vibration of the steering wheel armature, others have engaged counter-vibration weights to the steering wheel armature. Unfortunately, known steering wheel counter-vibration weights are not without their respective drawbacks.

One system for altering the vibrational characteristic of a steering wheel armature discloses connecting a variable capacity bladder to the armature assembly. Although the bladder allows unique tuning of the mass attributable to the bladder, such a methodology substantially complicates the overall construction of the steering wheel assembly and dramatically increases the cost associated with manufacturing and maintaining proper operation of the steering wheel assembly.

Rather than manipulating the weight of the steering wheel armature, others provide a multiple layer or segmented steering wheel assembly wherein a vibration dampening media or connection is positioned or formed between the grip areas and the underlying rigid structures of the steering wheel armature in an effort to mitigate the detrimental effects of steering wheel vibration. Although such systems provide vibration isolation between the user's hands and the steering wheel, such systems also substantially complicate the manufacture and expense associated with forming the steering wheel assembly. Such systems can also detract from the responsiveness of the vehicle steering system to user inputs. For instance, when a user initiates an aggressive steering input, the flexible vibration dampening media must first deflect or deform before the user steering input is communicated through the steering assembly to the steering shaft. Accordingly, each of the flexible connections or dampening media, although isolating the user from steering wheel vibration, yields a steering system that is less than desirably responsive to user steering inputs.

Still others, having recognized some of the shortcomings of the systems discussed above, have developed steering wheel armature weighting systems that mitigate or reduce vibration of the steering wheel armature by placing one or more weights about the circumference of the steering wheel assembly. Although such weight systems dampen vibration of the steering wheel armature, such weight systems are also not without their drawbacks.

Commonly, one or more weights are positioned with respect to the underlying armature and then secured thereto with a supplemental fastener or connection mechanism. The supplemental fasteners commonly include screws, clips, or ties that are positioned to interact with both of the weight and the steering wheel armature to positionally fix the weight relative to the armature. Unfortunately, the process of connecting each weight to the steering wheel armature requires manual manipulation of one or more fasteners for each weight associated with each steering wheel armature. Such supplemental connection systems also result in additional manufacturing overhead associated with the consumable connectors or bonding agents, increased labor costs, reduced product processing throughputs, and less than desirable product repeatability. Although such connections can be conveniently preformed by only minimally skilled labor and without expensive and/or complicated equipment, such connection systems also alter the mass associated with each weight and thereby alter the vibration performance of the steering wheel assembly.

Accordingly, there is a need for a steering wheel weight and armature assembly and method of forming a steering wheel armature wherein a counter vibration weight can be quickly and conveniently secured to a steering wheel armature. There is also a need for a steering wheel armature weighting system wherein the process of securing the weight to the steering wheel armature does not alter the mass associated with the weighted steering wheel armature assembly.

### BRIEF SUMMARY OF THE INVENTION

The present invention provides a steering wheel weight and supplemental weighted steering wheel armature assembly that overcomes one or more of the aforementioned drawbacks. One aspect of the invention discloses a steering wheel weight formed as a body and having a generally curvilinear shape in a plane that is generally aligned with a longitudinal axis of the body. Preferably, the steering wheel weight is constructed so that the weight can be crimped to a steering wheel armature thereby securely connecting the steering wheel weight to the steering wheel armature without extraneous fasteners/connectors.

Another aspect of the invention usable with one or more of the above aspects discloses a steering wheel weight that defines a body formed of a metal material. The body has a generally curvilinear shape in a first direction that is generally transverse to a longitudinal axis of the body. The body includes at least one indexer that extends from the body. The indexer is constructed for positioning the body with respect to a steering wheel armature so that the curvilinear shape of the body generally aligns with a curvilinear shape of at least a portion of the steering wheel armature. At least one tab extends from the body and is deformable relative to the body for securing the body to the steering wheel armature so that the body is positionally securable to the steering wheel armature by only deformation of the tab.

Another aspect of the invention usable with one or more of the above aspects discloses a steering wheel armature assembly. The assembly includes an armature that has a grip portion that is positioned radially outward with respect to a hub portion of the armature. The hub portion of the armature is constructed to secure the armature to a steering mechanism. The assembly includes at least one weight that is shaped to generally match a shape of a portion of the grip portion of the armature. A first arm extends from the weight and is deformable to provide a snug over-center association of the weight and the armature so that the over-center association between the weight and the armature is all that secures the weight to the armature.

Another aspect of the invention usable with one or more of the above aspects discloses a method of forming a steering wheel armature. The method includes indexing a weight relative to a steering wheel armature. Once indexed or positioned relative to the armature, the weight is secured to the steering wheel armature by only physical interaction of the weight and the steering wheel armature and in a manner that snuggly fixes the position of the weight relative to the steering wheel armature to maintain the position of the weight relative to the steering wheel armature independent of the orientation of the steering wheel armature.

These and various other features and advantages of the present invention will be made apparent from the following detailed description and the drawings.

### BRIEF DESCRIPTION OF THE DRAWING

The drawings illustrate one preferred embodiment presently contemplated for carrying out the invention.

In the drawings:

FIG. 1 is a perspective view of an operator area of a vehicle equipped with a steering wheel according to the present invention;

FIG. 2 is a plan view of the steering wheel assembly shown in FIG. 1 removed from the exemplary vehicle shown in FIG. 1;

FIG. 3 is a perspective view of the steering wheel assembly shown in FIG. 2 with an overlay or covering removed therefrom and exposing a steering wheel armature assembly with a steering wheel armature weight exploded from the armature;

FIG. 4 is a view similar to FIG. 3 and shows a various armature weights engaged with the steering wheel armature shown in FIG. 3;

FIG. 5 is a perspective view of the weight shown in FIG. 3;

FIG. 6 is a perspective view of an armature facing side of the weight shown in FIG. 5;

FIG. 7 is a view of a cross section of the weight shown in FIG. 5 with respect to a section aligned with a radius associated with a longitudinal curvature of the weight;

FIG. 8 is a plan view of the weight shown in FIG. 5;

FIG. 9 is a detailed perspective view of one of the weights shown in FIG. 4 with the weight engaged with the steering wheel armature taken along line 9-9 shown in FIG. 4; and

FIG. 10 is a view of a cross section of weight and armature assembly taken along line 10-10 shown in FIG. 9 and shows an over-center orientation of portions of the weight relative to the armature.

### DETAILED DESCRIPTION OF THE INVENTION

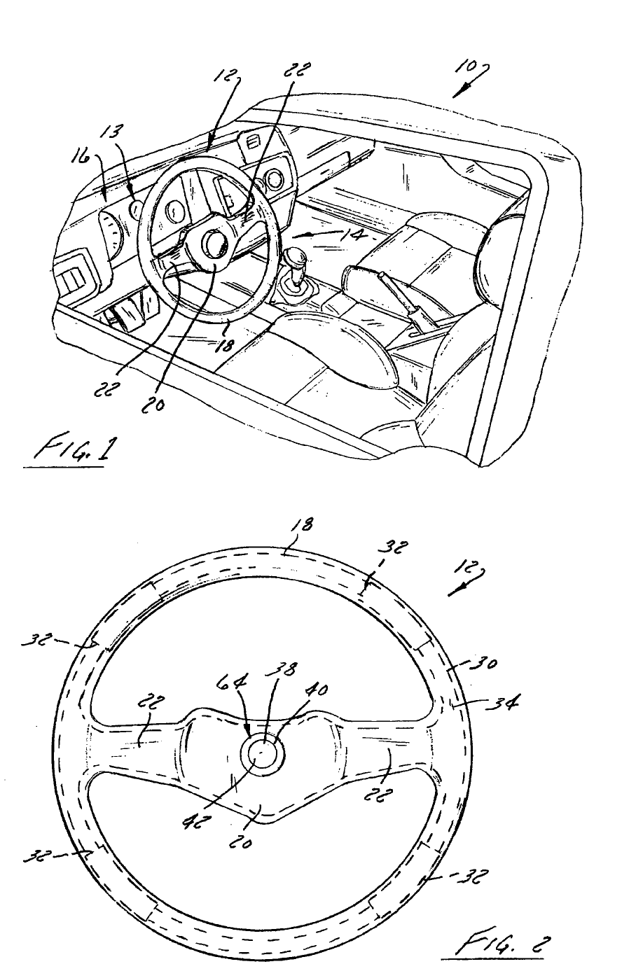

An exemplary vehicle 10 equipped with a steering wheel assembly 12 according to the present invention is shown in FIG. 1. It is appreciated that, although configured for use with automobiles, the present invention is usable with other machines or devices wherein machine vibration can be transferred to the user through a steering wheel or other user input configured to be gripped by an operator for controlling operation of the underlying machine, equipment, or device such as automobiles, recreational vehicles, agricultural and/or industrial equipment.

Regardless of the configuration of vehicle 10, steering wheel assembly 12 includes a first side 14 that generally faces an operator and a second side 16 that generally faces adjacent structure of the underlying vehicle, such as an instrument cluster 13. Steering wheel assembly 12 includes a grip portion 18 that is connected to a hub portion 20 by one or more spoke or web portions 22. Grip portion 18 preferably extends circumferentially and concentrically about hub portion 20. Those skilled in the art will appreciate that the shape of steering wheel assembly 12 is merely exemplary of a fairly common steering wheel shape. It is appreciated that steering wheel assembly 12 could have virtually any shape comfortable for user including non-circular shapes.

Referring to FIG. 2, steering wheel assembly 12 includes a steering wheel armature 30, one or more weights 32 that are engaged therewith, and a sheathing or cover 34 that substantially encloses armature 30 and weights 32. As described further below, weights 32 are selectively distributed about the circumference or available area of grip portion 18 of steering wheel assembly 12. It is further appreciated that specifics of the construction and operating performance of the underlying vehicle 10 may determine the location of weights 32 about grip portion 18 of armature 30. It is further appreciated that the operation and construction of vehicle 10 may further define those areas of grip potion 18 of armature 30 where no weights are preferred and/or allowed. Those skilled in the art will appreciate that the vibrational performance of the underlying vehicle will largely determine the location of weights 32 relative to armature 30.

As shown in FIGS. 2-4, hub portion 20 of armature 30 includes steering shaft mount 64 that includes a passage 38 and a stop or land 40 that are configured to cooperate with the steering shaft 42 of vehicle 10. Steering wheel assembly 12 is constructed to be secured to a vehicle steering shaft so that rotation of steering wheel assembly 12 effectuates a steering response in the underlying vehicle. It is appreciated that any number of interfaced, such as a splined or other telescopic interference connection, may be formed between steering shaft mount 64 and the underlying steering shaft of the vehicle to effectuate the desired steering response. Regardless of the specific shape or methodology of the connection between the steering shaft of the vehicle and steering wheel assembly 12, grip portion 18 is preferably concentrically oriented with respect to the rotational axis of steering shaft 42 so that rotation of the steering wheel does not substantially alter the outermost location of the grip portion 18 of the steering wheel assembly 12 relative to the axis of rotation thereof. Such a construction maintains a comfortable orientation of grip portion 18 throughout the rotational operating range of steering wheel assembly 12.

Cover 34 is constructed to generally overlap and/or encase steering wheel armature 30 and weights 32. Preferably, cover 34 extends continuously over the entirety of armature 30 and weights 32. Cover 34 can be constructed of any of a number of materials including plastics, leather materials, inlay materials, and/or any combination thereof. Preferably, at least a portion of cover 34 is molded over armature 30 and weights 32. More preferably, cover 34 is formed of a material and a variable thickness such that the location, size, and/or shape of weights 32 cannot be perceived by a user gripping steering wheel assembly 12 at locations associated with one or more of weights 32.

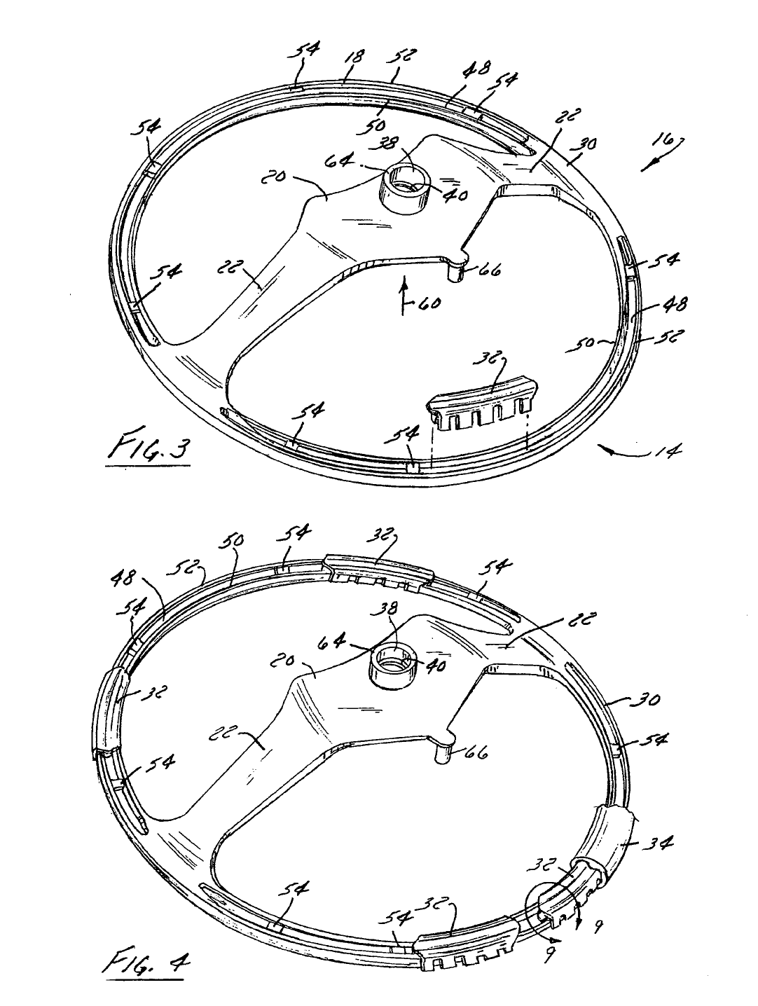

FIGS. 3 and 4 show steering wheel assembly 12 with cover 34 removed therefrom. Referring to FIG. 3, one or more channels or grooves 48 are formed in vehicle facing side 16 of grip portion 18 of steering wheel armature 30. Each groove 48 is defined by a radially inward wall 50 and a radially outward wall 52, as determined by a distance from the axis of curvature of grip portion 18, of steering wheel armature 30. Armature 30 includes one or more indexers or bosses 54 that define the positioning of one or more weights 32 relative to steering wheel armature 30. Web portions 22 of armature 30 extend in a radially inward direction and a direction, indicated by arrow 60, toward vehicle 10 relative to grip portion 18. Alternate web portions 22 are connected to one another by hub portion 20 of armature 30. Although steering wheel armature 30 is shown to include two web portions 22, it is appreciated that one or more than two web portions 22 may be provided between hub portion 20 and grip portion 18.

Hub portion 20 of armature 30 includes a steering shaft mount 64 and an optional auxiliary mount 66. Steering shaft mount 64 and optional auxiliary mount 66 extend in generally opposite directions from hub portion 20 of steering wheel armature 30. Optional auxiliary mount 66 is commonly utilized for securing supplemental vehicle components, such as a horn, vehicle lights, radio, and/or cruise control controls and/or switches to steering wheel assembly 12 so that an operator can manipulate such systems without disengaging from steering wheel assembly 12.

As shown in FIGS. 3 and 4, steering wheel assembly 12 includes one more weights 32 that are secured to steering wheel Armature 30. Each weight 32 is secured to armature 30 without the use of extraneous fasteners or securing means such as bonding agents—like glue or adhesives, threaded fasteners—such as bolts or screws, ties—such as plastic or metal cable or zip wires or ties, clips—such as E or C shaped metal or plastic clips, etc. Preferably, each weight 32 is crimped to the underlying armature 30 so that the crimped interaction is all that secures each weight 32 relative to armature 30. Preferably, the process of crimping the one or more weights 32 to steering wheel armature 30 alters the shape of one of the armature and the weight so as to provide a fairly robust interference that maintains the position of each weight 32 relative to armature 30 independent movement and orientation of the armature.

Referring to FIGS. 5-8, each weight 32 is formed as a continuous one-piece body 70. Preferably, body 70 is cast or molded from a metal type material. More preferably, body 70 is formed of a zinc based material such as zinc alloy #3 or AG40A in a high pressure die cast process. Body 70 includes a first side 72 that faces away from steering wheel armature 30 and a second side 74 that faces toward armature 30 when each weight 32 is engaged therewith. An indexer or rib 78 extends along second side 74 of body 70. One or more arms or tabs 80, 82 also extend from one or more of alternate lateral or radial sides, indicated by arrow 76, of body 70 from second side 74 of body 70. Arms 80, 82 and rib 78 extend in a common direction such that arms 80, 82 generally flank rib 78. One or more grooves or slots 84, 86 are aligned with tabs 80, 82 to define a number of individual arms 80, 82 along each alternate lateral side of body 70. As described further below with respect to FIGS. 9 and 10, slots 84, 86 allow inward deflection of one or more of arms 80, 82 of weight 32 and compression of the arm about armature 30 so as to fix the position of each respective weight 32 relative to armature 30 by only crimping.

Referring to FIGS. 5 and 8, body 70 has a longitudinal axis, indicted by line 92, that is generally aligned with the longest dimension of body 70. Longitudinal axis 92 has a curvature that generally matches the curvature of grip portion 18 of armature 30. Said in another way, longitudinal axis 92 of body 70 is curved about the axis of rotation of steering shaft 42. Alternate longitudinal ends 94, 96 of body 70 include curved corners 98, 100, 102, 104 that minimize the bluntness of the termination of body 70. As shown in FIGS. 5, 7, and 8, first side 72 of each weight includes a groove or channel 110 that extends along the longitudinal length of body 70. Voidance of the volume associated with channel 110 affects the mass of body 70 but also assists with post weight secured processing of steering wheel assembly 12. Channel 110 facilitates the thickening of the material associated with the formation of cover 34 in the proximity of weights 32. During formation of injection molded cover materials, channel 110 forms a material passage for the injection material to alternate sides of each weight 32. Channel 110 reduces the detrimental effects, such as voids or cavities and increased operating pressures, associated with restrictions and/or interruptions to the flow of cover materials, such as foam, around the steering wheel armature assembly during molding and/or subsequent processing. For steering wheel assemblies equipped with overlay or inlay cover materials, channel 110 allows increases in the thickness of such materials to maintain a desired structural stability of such materials without unduly increasing the overall size of grip portion 18 of steering wheel assembly 12.

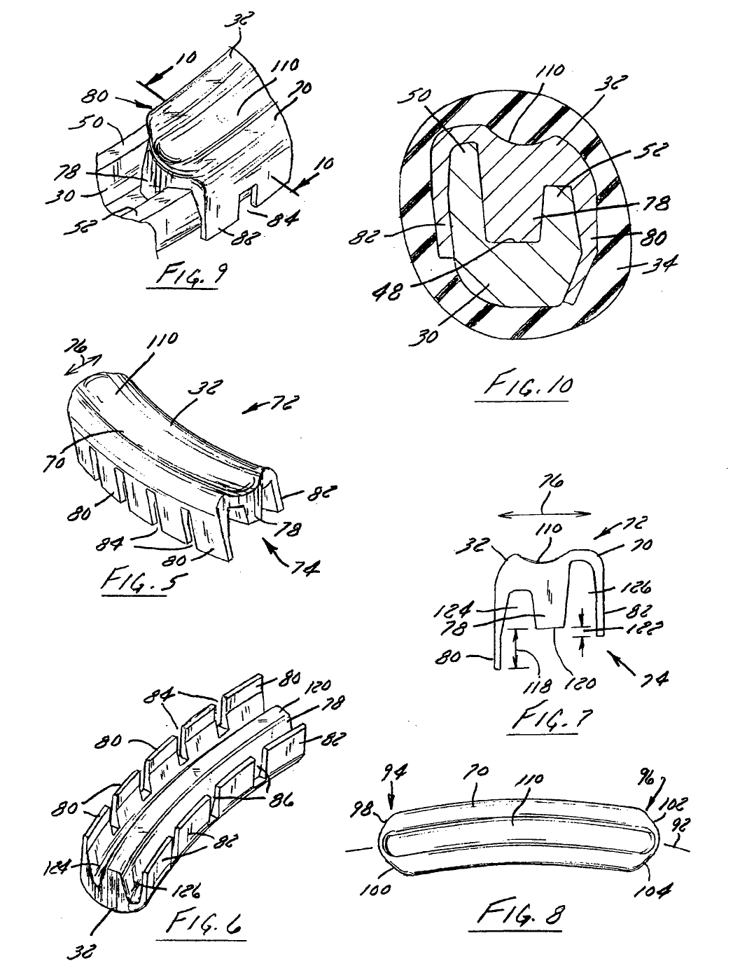

Referring to FIG. 7, arms 80 extend a first distance, indicated by arrow 118, beyond a distal tip 120 of rib 78 and arms 82 extend a second distance, indicated by arrow 122, beyond distal tip 120. As shown in FIG. 7, distance 118 that arms 80 extend beyond rib 78 is greater than distance 120 that arms 82 extend beyond rib 78. Referring to FIGS. 7, 9 and 10, when weights 32 are positioned relative to armature 30, rib 78 of each weight 32 is received in groove 48 of armature 30 so that the radially inward and radially outward walls 50, 52 of armature 30 extend into a cavity 124, 126 formed between each arm 80, 82 and rib 78 of weight 32. Said in another way, radially inward wall 50 of armature 30 is flanked or captured between rib 78 and arm 82 of weight 32 whereas radially outward wall 50 of armature 30 is flanked or captured between rib 78 and arm 80 of the respective weight 32. As shown in FIG. 10, after each respective weight 32 has been positioned with respect armature 30, each weight is crimped to achieve an over-center orientation that secures position and orientation of each weight 32 relative to armature 30. As is commonly understood and as used herein, over-center is an orientation wherein the geometric spatial relationship of one part relative to another part, includes portions thereof that extend beyond the centerline or specific portion of one part and are contoured or otherwise oriented to maintain the position of the one part relative to the second part. It is further appreciated that such an over-center orientation need not be assessed with respect to the entirety of either part but can be assessed relative only to the overlapping portions of the respective structures.

Once oriented and crimped, the position and orientation of each weight 32 is fixed with respect to armature 30 so that the armature 30 and attached weights can be subsequently processed, such as being handled, packaged, shipped, wrapped, and/or molded, such as during the application of cover 34 without affecting the position or orientation of weights 32 relative to armature 30. Those skilled in the art will further appreciate that the fastenerless connection of each weight 32 to underlying armature 30 simplifies individualization of steering wheel assembly for use with alternate steering wheel configurations. That is, as no extraneous fasteners or clips or securing means are required for securing weights 32 to armature 30, the intended mass of each weight 32 is all that is contributed to armature 30. Accordingly, the present invention simplifies the design considerations for forming a separate mass weighted steering wheel armature assembly for use with different vehicles.

In a preferred embodiment, the weighted steering wheel armature assembly has four weights 32 secured to the underlying armature 30. In a preferred embodiment, each weight 32 contributes about 0.1616 lbs. to the overall mass of the steering wheel armature assembly. It is appreciated that the mass of each weight 32, the mass of the weighted armature assembly, and the location and number of weights 32 can be manipulated so as to provide a desired vibration dampening performance that is tailored to a specific vehicle, class of vehicle, or operating conditions wherein it is desired to reduce the vibration of the steering wheel assembly 12. The proposed assembly provides the use of reduced or minimal weight increments to be used in sufficient quantities to provide the desired dampening suited to a particular vehicle and steering wheel application so as to reduce or minimize the weight increase associated with each steering wheel. Connecting one or more weights to an armature assembly is an economical manner of forming such a steering wheel assembly. Connecting the one or more weights to the underlying steering wheel assembly without extraneous fasteners or bonding agents simplifies the manufacture and reduces the cost associated with the formation of each steering wheel assembly while maintaining a highly tuneable product platform that can be quickly and economically tailored to be usable with a number of product types and operating conditions.

Therefore, one embodiment of the invention is a steering wheel weight. The weight includes a body that is formed of a metal material and which has a curvilinear shape in a plane that is generally aligned with a longitudinal axis of the body. At least one indexer extends from the body and is constructed to position the body with respect to a steering wheel armature so that the curvilinear shape of the body generally aligns with a curvilinear shape of at least a portion of the steering wheel armature. The weight includes at least one tab that extends from the body and is deformable relative to the body for securing the steering wheel armature so that the body is positionally securable to the steering wheel armature by one deformation of the at least one tab.

Another embodiment of the invention usable with one or more features of the above embodiment includes a steering wheel armature assembly that includes an armature having a grip portion that is positioned radially outward with respect to a hub portion of the armature. The hub portion of the armature is constructed to secure the armature to a steering mechanism. The assembly includes at least one weight that is shaped to generally match a shape of a portion of the grip portion of the armature. A first arm extends from the weight and is deformable to provide a snug over-center association of the weight and the armature so that the over-center association between the at least one weight and the armature solely secures the at least one weight to the armature.

Another embodiment of the invention that is usable with one or more of the features of the above embodiments includes a method of forming a steering wheel armature. The method includes indexing a weight relative to a steering wheel armature and securing the weight to the steering wheel armature by only physical interaction of the weight and the steering wheel armature and in a manner that snuggly fixes the position of the weight relative to the steering wheel armature to maintain the position of the weight relative to the steering wheel armature independent of the orientation of the steering wheel armature.

The present invention has been described in terms of the preferred embodiment, and it is recognized that equivalents, alternatives, and modifications, beyond those expressly stated, are possible and within the scope of the appending claims.

What is claimed is:

1. A steering wheel weight comprising:
a body formed from a metal material and having a curvilinear shape in a plane generally aligned with a longitudinal axis of the body;
at least one indexer extending from the body for positioning the body with respect to a steering wheel armature so that the curvilinear shape of the body generally aligns with a curvilinear shape of at least a portion of the steering wheel armature; and
at least one tab extending from the body and being deformable relative to the body for securing the body to the steering wheel armature so that the body is positionally securable to the steering wheel armature by only deformation of the at least one tab.

2. The steering wheel weight of claim 1 further comprising a plurality of tabs that extend from the body.

3. The steering wheel weight of claim 2 further comprising a slot formed between adjacent tabs.

4. The steering wheel weight of claim 3 wherein each tab is deformable toward the armature.

5. The steering wheel weight of claim 2 wherein at least two of the plurality of tabs extend from radially inner and radially outer sides of the body as defined by the curvilinear shape of the body.

6. The steering wheel weight of claim 1 wherein the indexer and the at least one tab extend in a common direction from the body.

7. The steering wheel weight of claim 6 further comprising a channel that extends along at least a portion of the body and is formed in a side of the body opposite the common direction.

8. The steering wheel weight of claim 1 further comprising a gap between the indexer and the tab wherein the gap has a first width when the tab is in a first position that loosely corresponds to a width of a rib that extends from the steering wheel armature and a second width that corresponds to the width of the rib when the tab is in a second position.

9. A steering wheel armature assembly comprising:
an armature having a grip portion that is positioned radially outward with respect to a hub portion constructed to secure the armature to a steering mechanism;
at least one weight having a shape that generally matches a shape of a portion of the grip portion of the armature; and
a first arm extending from the at least one weight, the first arm being deformable to provide a snug over-center association of the least one weight and the armature and wherein the over-center association between the at least one weight and the armature solely secures the at least one weight to the armature.

10. The assembly of claim 9 wherein the over-center association is achieved by crimping the first arm to the armature when the armature is positioned therebehind.

11. The assembly of claim 9 further comprising a second arm that is separated from the first arm by a gap that extends in a crossing direction relative to a deformation direction associated with movement of the arm.

12. The assembly of claim 11 further comprising a third arm that is on an opposite lateral side of the weight that is opposite the first and second arms.

13. The assembly of claim 9 further comprising another weight that is secured to the armature at a position offset from the weight along the circumference of the armature.

14. The assembly of claim 13 wherein each weight it secured to a side of the armature that faces a driver.

15. The assembly of claim 9 further comprising a longitudinal groove formed in a side of the weight that faces a driver and a ridge formed in a side of the weight that faces the armature and which is shorter than the first arm.

16. A method of forming a steering wheel armature comprising:
indexing a weight relative to a steering wheel armature; and
securing the weight to the steering wheel armature by only physical interaction of the weight and the steering wheel armature and in a manner that snuggly fixes the position of the weight relative to the steering wheel armature to maintain the position of the weight relative to the steering wheel armature independent of the orientation of the steering wheel armature.

17. The method of claim 16 further comprising securing another weight to the steering wheel armature at a position offset from the weight along the circumference of the steering wheel armature.

18. The method of claim 16 wherein indexing the weight relative to the steering wheel armature includes positioning a center portion of the weight between adjacent portions of the steering wheel armature so as to define a radial distance of the weight from a radial center of the steering wheel armature.

19. The method of claim 16 wherein securing the weight includes crimping the weight to the steering wheel armature.

20. The method of claim 19 wherein crimping the weight to the steering wheel armature includes biasing at least one arm of the weight toward an over-center orientation with respect to an underlying portion of the steering wheel armature.
